(19) United States
(12) Patent Application Publication
(10) Pub. No.: US 2004/0125164 A1
(43) Pub. Date: Jul. 1, 2004

(54) Printer with structure providing edge printing and a shingling method thereof

(76) Inventors: Jin-ho Park, Gyeonggi-do (KR); Seung-don Lee, Gyeonggi-do (JP)

Correspondence Address: STANZIONE & KIM, LLP, 1740 N STREET, N.W., FIRST FLOOR, WASHINGTON, DC, 20036, US

(21) Appl. No.: 10/671,940

(22) Filed: Sep. 29, 2003

(30) Foreign Application Priority Data
Oct. 1, 2002 (KR) 2002-59773
Oct. 15, 2002 (KR) 2002-62695

(51) Int. Cl. B41J 29/38

(52) U.S. Cl. 347/16

(57) ABSTRACT

A printer and shingling method providing edge printing on a printing medium. The shingling method includes feeding paper such that an edge portion of the paper is located under a nozzle unit of an ink head and printing first data on the edge portion of the paper, which is positioned between support beams supporting the paper, the first data being generated by masking data corresponding to positions of the support beams; and moving the paper in a paper feed direction by a predetermined width and printing second data on the edge portion of the paper, which is positioned between support beams.

### CROSS-REFERENCE TO RELATED APPLICATIONS

This application claims the priority of Korean Patent Application No. 2002-59773, filed on Oct. 1, 2002, and Korean Patent Application No. 2002-62695, filed on Oct. 15, 2002, in the Korean Intellectual Property Office, the disclosures of which are incorporated herein by reference.

### BACKGROUND OF THE INVENTION

1. Field of the Invention

The present invention relates to a printer and a shingling method, and more particularly, to a printer providing edge printing and a shingling method thereof.

2. Description of the Related Art

FIG. 1 is a diagram of a conventional printer. Referring to FIG. 1, in the conventional printer, a paper 11 is fed between a paper feed roller 12 and a pressure roller 14 in a paper feed direction. When the paper 11 is located under a head 15, ink in an ink cartridge (not shown) installed at the head 15 is expelled onto the paper 11 through nozzles (not shown), and thus printing starts. The head 15 performs a reciprocating motion in a scan direction, i.e., a direction perpendicular to the paper feed direction, while expelling ink. After completion of printing, the paper 11 is discharged by a discharge roller 16 and a star wheel 18.

FIG. 2 is a diagram showing a state of paper on which printing by the conventional printer shown in FIG. 1 has been completed. As shown in FIG. 2, when a user sets the printer to perform printing on a full area of the paper 11, printing is actually performed only in a printed area 11-E of the paper 11, and not in edge areas 11-A, 11-B, 11-C, and 11-D. The conventional printer is designed such that printing is not performed in the edge areas 11-A, 11-B, 11-C, and 11-D even if the user sets a margin to 0.

In order to overcome this problem, U.S. Patent Application No. 2002/0070991 A1 discloses a printer performing edge printing without contaminating rollers, and a shingling method.

FIG. 3 is a side elevation view of the printer disclosed in U.S. Patent Application No. 2002/0070991 A1. Referring to FIG. 3, a paper P is supported by upper feed rollers 25a and 25b and transported in a paper feed direction. The front edge Pf of the paper P passes over a front support beam 26f and a platen 26 and reaches a rear support beam 26r. At this time, ink Ip is expelled from the head 28 by nozzles #1 through #8, and thus printing starts. Even when the paper P is transported askew, since printing starts before the front edge Pf of the paper P reaches the first nozzle #1, printing can be performed starting from the front edge Pf without a margin. Ink drops, which digress from the paper P and are not absorbed into the paper P, are absorbed by absorption members 27f and 27r. When the front edge Pf of the paper P is transported passing between discharge roller 25c and 25d, a rear edge Pr of the paper P passes over the front support beam 26f and the platen 26 toward the rear support beam 26r. Printing for the rear edge Pr of the paper P is performed in the same manner as printing for the front edge Pf of the paper P.

Recently, a printable width per reciprocation of an ink head, that is, the width of the ink head, has been increased in order to improve a printing speed of a printer. In order to increase the width of the ink head, the width of the platen 26 must also be increased. When increasing the width of the platen 26, a distance between the front support beam 26f and the rear support beam 26r is increased, so it is difficult to guide the paper P in parallel throughout a printing section.

In addition, when a platen has two openings at the upper portions, the likelihood of paper being jammed into spaces between the support beams and the platen increases. Accordingly, a shingling method to control a printing operation is not continuous throughout a printing section, but different, and complex operations are required for the front, middle, and rear portions of paper. Moreover, in order to perform normal printing on the middle portion of paper, only some of the nozzles are used, which decreases a printing speed.

In addition, the rear edge of paper must be located above a slot between support beams, so shingling for arranging paper at various nozzle positions is limited, the amount of feeding during printing on an edge portion of paper decreases, and a high mechanical accuracy is required. Moreover, when performing shingling without feeding paper, an effect of reducing a nozzle variation decreases as compared to a normal shingling method, and thus the quality of a picture is degraded.

### SUMMARY OF THE INVENTION

It is an aspect of the present invention to provide a printer with a structure to prevent paper from being jammed, and effectively performing edge printing with a simple method.

It is another aspect of the present invention to provide a shingling method by which printing can be effectively performed at an edge of a paper without a margin.

Additional aspects and advantages of the invention will be set forth in part in the description which follows and, in part, will be obvious from the description, or may be learned by practice of the invention.

The forgoing and/or other aspects of the present invention are achieved by providing a printer comprising an ink head comprising a nozzle unit to eject ink drops in a shingling mode to provide edge printing, an ink collector positioned under a paper or other printing medium to correspond to the nozzle unit and collect ink digressing from the paper, and a plurality of support beams extending at an upper portion of the ink collector in a paper feed direction and in an opposite direction to the paper feed direction and alternately arranged with each other in a scan direction.

In an aspect of the invention, the support beams comprise a first support beam extending from a paper feed side of the ink collector in the paper feed direction; and a second support beam extending from a paper discharge side of the ink collector in the opposite direction to the paper feed direction.

In another aspect of the invention, the first and second support beams extend to have the same length so as to support the paper.

In another aspect of the invention, the end points of the first support beam and the second support beam face each other in the scan direction, or the end portion of the first support beam extend in the paper feed direction to interlace with that of the second support beam.

In yet another aspect of the invention, the first and second support beams have the same height in a direction toward the ink head, the direction perpendicular to the paper feed direction and the scan direction.

In yet another aspect of the invention, the support beam extends from a barrier partitioning the ink collector, or the support beam is a rib, which segments a space of the ink collector without partitioning it.

In yet another aspect of the invention, the second support beam has a round end portion or a slant end portion inclining in the paper feed direction.

The foregoing and/or other aspects of the present invention may also be achieved by providing a shingling method to provide edge printing. The shingling method comprises feeding paper such that an edge portion of the paper is located under a nozzle unit of an ink head and printing first data on the edge portion of the paper, which is positioned between support beams supporting the paper, the first data being generated by masking data corresponding to positions of the support beams; and moving the paper in a paper feed direction by a predetermined width and printing second data on the edge portion of the paper, which is positioned between the support beams.

Here, the first data and the second data are in a complementary relationship.

In an aspect of the invention, in the paper feeding operation, masking is performed using a first mask, in which a number of consecutive 0% printing columns, which are alternately distributed with 100% printing columns, gradually change in inverse proportion to the number of consecutive 100% printing columns in a scan direction perpendicular to the paper feed direction.

In another aspect of the invention, in the paper moving operation, the second data is generated by performing masking using a second mask, which is in a complementary relationship with the first mask.

In another aspect of the invention, in the paper feeding operation, the support beams extend from a paper feed side in the paper feed direction, and in the paper moving operation, the support beams extend from a paper discharge side in an opposite direction to the paper feed direction and interlace with the support beams extending from the paper feed side.

In yet another aspect of the invention, the support beams are part of an ink collector, which collects ink digressing from the paper.

In still another aspect of the invention, in the paper feeding operation, the paper is fed by ½ of a width of the nozzle unit in the paper feed direction, and in the paper moving operation, the paper is fed by ½ of the width of the nozzle unit in the paper feed direction.

In still another aspect of the invention, in the paper moving operation, the second data is applied to a nozzle section positioned above the edge portion of the paper, and the other nozzle section operates in a shingling mode to provide normal printing.

In still a further aspect of the invention, the shingling method further comprises moving the paper in the paper feed direction after completing front edge printing in the paper moving operation and performing printing in a normal shingling mode.

In still a further aspect of the invention, the shingling method further comprises performing printing in a normal shingling mode before the paper feeding operation, wherein printing is performed in a shingling mode to provide rear edge printing in the paper feeding operation.

The foregoing and/or other aspects of the present invention may also be achieved by providing a printer comprising an ink head ejecting ink drops at an edge of a printing medium, an ink collector positioned under the printing medium to collect excess ink from the printing medium, a plurality of first support beams extending at an upper portion of the ink collector in a printing medium feed direction to support the printing medium at a printing medium feed side of the ink collector, and a plurality of second support beams extending at an upper portion of the ink collector in an opposite direction to the printing medium feed direction and alternately arranged with the plurality of first support beams to support the printing medium at a printing medium discharge side of the ink collector.

In another aspect of the invention, the ink head comprises an ink nozzle unit to eject the ink drops on the printing medium when the ink head moves in a scan direction.

In yet another aspect of the invention, the ink collector is located under the printing medium and has a width corresponding to a width of the ink nozzle unit. However, the ink collector may alternatively have a width wider than the width of the ink nozzle unit.

In yet a further aspect of the invention, the ink collector comprises a plurality of space portions, and a plurality of barriers separating the plurality of adjacent space portions, wherein the first and second support beams integrally extend from the barriers alternately with respect to each other.

The foregoing and/or other aspects of the present invention may also be achieved by providing a printer comprising an ink head ejecting ink drops at an edge of a printing medium, an ink collector positioned under the printing medium to collect excess ink from the printing medium, a plurality of first support beams extending at an upper portion of the ink collector in a printing medium feed direction to support the printing medium at a printing medium feed side of the ink collector; and a plurality of second support beams extending from an upper portion of the ink collector at a printing medium discharge side of the ink collector and in an opposite direction to the printing medium feed direction, the plurality of second support beams being overlapped by the plurality of first support beams to support the printing medium during feeding thereof between the ink head and the ink collector.

In an aspect of the above method, in the printing medium feeding operation, first data is generated by performing masking using a first mask.

In a further aspect of the above method, in the printing medium moving operation, second data is generated by performing masking using a second mask, which is in a complementary relationship with the first mask.

In yet a further aspect of the above method, masking is performed using the first mask in which a number of consecutive 0% printing columns, which are alternately distributed with a number of 100% printing columns, gradually changes in inverse proportion to the number of consecutive 100% printing columns in a scan direction perpendicular to the printing medium feeding direction.

In another aspect of the above method, the shingling further comprises moving the printing medium in the feeding direction after completing front edge printing and performing normal shingling printing, printing first data on a rear edge portion of the printing medium at positions between a set of support beams supporting the printing medium, and moving the printing medium in a feed direction by a predetermined distance and printing second data on the rear edge portion of the printing medium at positions complimentary to the first data such that the complete edge of the printing medium receives printing data.

In another aspect of the above method, in the printing medium feeding operation, the first data is generated by performing masking using a first mask and the second data is generated by performing masking using a second mask, which is in a complementary relationship with the first mask.

In yet another aspect of the above method, masking is performed using the first mask in which a number of consecutive 0% printing columns, which are alternately distributed with a number of 100% printing columns, gradually changes in inverse proportion to the number of consecutive 100% printing columns in a scan direction perpendicular to the printing medium feeding direction.

### BRIEF DESCRIPTION OF THE DRAWINGS

These and other objects and advantages of the present invention will become apparent and more readily appreciated from the following description of the embodiments, taken in conjunction with the accompanying drawings of which:

FIG. 1 is a schematic diagram of a conventional printer;

FIG. 2 is a diagram showing a state of paper, on which printing is performed by a conventional printer;

FIG. 3 is a side elevation view of a conventional printer;

FIGS. 4A and 4B are schematic diagrams of printers according to two embodiments of the present invention, respectively;

FIG. 5 is a perspective view of the printers according to the embodiments of the present invention shown in FIGS. 4A and 4B;

FIG. 6 is a diagram showing a state in which paper is fed to provide edge printing in the printers according to the embodiments of the present invention shown in FIGS. 4A and 4B;

FIG. 7A is a perspective view of a first modified example of an ink collector of the printers according to FIGS. 4A and 4B;

FIG. 7B is a perspective view of a second modified example of the ink collector of the printers according to FIGS. 4A and 4B;

FIG. 8 is a flowchart of a shingling method providing edge printing according to an embodiment of the present invention;

FIGS. 9A through 9C are diagrams showing the stages in a shingling method providing front edge printing according to an embodiment of the present invention;

FIGS. 10A through 10C are diagrams showing the stages in a shingling method providing rear edge printing according to an embodiment of the present invention; and

FIGS. 11A through 1C are diagrams showing examples of masks used in a shingling method according to the present invention.

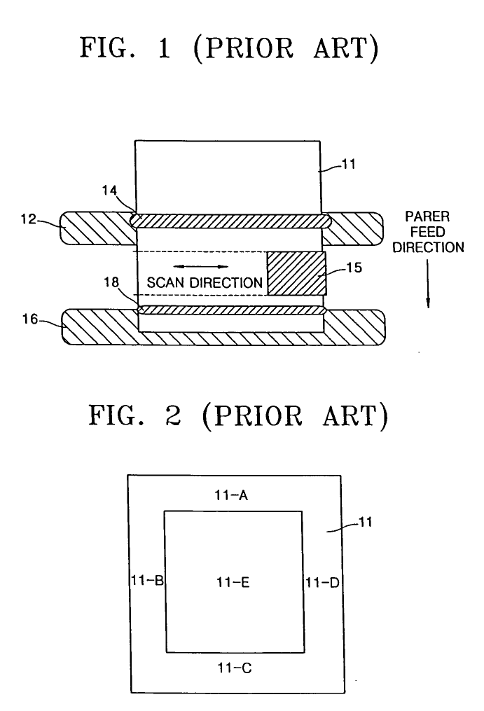

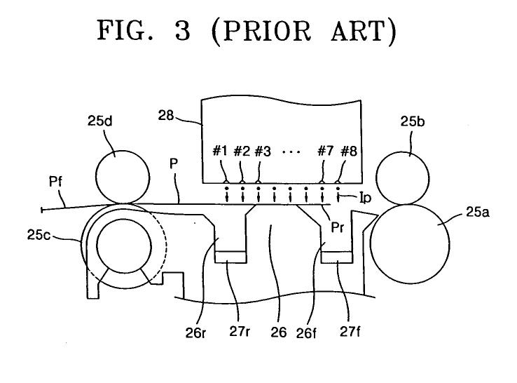

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

The present invention provides an ink collector allowing a shingling mode providing edge printing so that printing can be performed from edge to edge of a paper without contaminating support beams forming the ink collector.

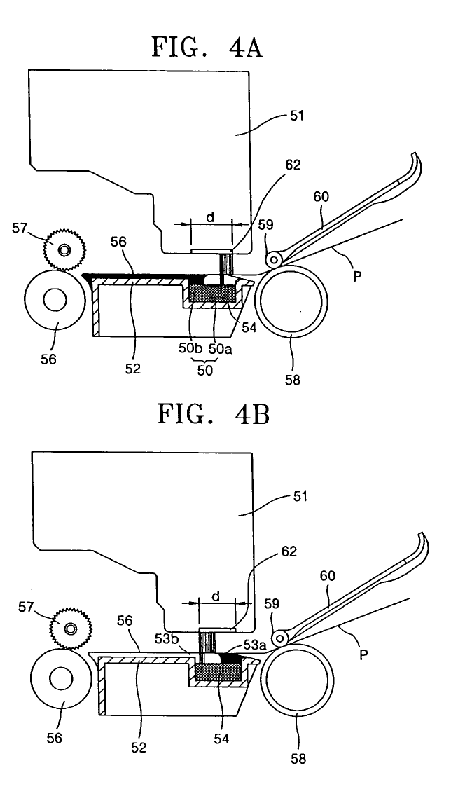

FIGS. 4A and 4B are schematic diagrams of printers according to embodiments of the present invention. Referring to FIGS. 4A and 4B, the printers include a feed roller 58 and a pinch roller 59, which are used to feed a paper P; an ink head 51, which performs printing by ejecting ink while moving in a scan direction perpendicular to a paper feed direction; first and second support beams 53a and 53b, respectively, which support the paper P and assist printing; a platen 52, which supports the first and second support beams 53a and 53b; and a discharge roller 56 and a star wheel 57, which are used to discharge the paper P. The pinch roller 59 presses the paper P using a friction arm 60. The first support beam 53a serves as a support beam at a paper feed side, and the second support beam 53b serves as a support beam at a paper discharge side.

The ink head 51 includes a nozzle unit 62 with a width “d” in the paper feed direction. The nozzle unit 62 ejects ink drops onto the paper P when the ink head 51 moves in the scan direction. An ink collector 50 is located under the paper and has a width corresponding to the width “d” of the nozzle unit 62. However, the width of the ink collector 50 is not restricted to the width “d” of the nozzle unit 62 and may be formed to be wider than the width “d” of the nozzle unit 62.

The ink collector 50 includes a single space or a plurality of spaces, which are parallel with the nozzle unit 62 in the scan direction. The ink collector 50 comprises a floor portion 50a and a space portion 50b having an opening above the floor portion 50a. In the printer shown in FIGS. 4A and 4B, the floor portion 50a is formed by extending the platen 52, and the space portion 50b is formed by stepping the platen 52 in order to collect ink therein. The space portion 50b is provided with a felt 54, which can absorb ink drops, so that ink can be efficiently collected.

The first and second support beams 53a and 53b are interlaced with each other in an upper portion of the opening of the ink collector 50 in order to guide the paper P. Each first support beam 53a extends from the platen 52 at a paper feed side in the paper feed direction, and each second support beam 53b extends from the platen 52 at a paper discharge side in an opposite direction to the paper feed direction. Here, the first support beam 53a and the second support beam 53b may have the same length, and ends of the first and second support beams 53a and 53b face each other in the scan direction. Alternatively, an end portion of the first support beam 53a may extend to overlap a part of the end portion of the second support beam 53b in the scan direction in order to more efficiently support the paper P. In FIG. 4A, the end portion of the first support beam 53a extends in the paper feed direction and overlaps a part of the end portion of the second support beam 53b. In FIG. 4B, the end of the second support beam 53b extends in the opposite direction to the paper feed direction and overlaps a part of the end portion of the first support beam 53a.

Unlike in the conventional technology, in the above embodiments of the present invention, a plurality of first and second support beams 53a and 53b are alternately arranged in the scan direction such that an end point of each first support beam 53a faces end points of an adjacent second support beam 53b in the scan direction, or end portions of the first and second support beams 53a and 53b are interlaced with each other, thereby preventing the paper P from being jammed. In addition, the widths of the first and second support beams 53a and 53b are made narrow to maximize a space to collect ink without contaminating the first and second support beams 53a and 53b.

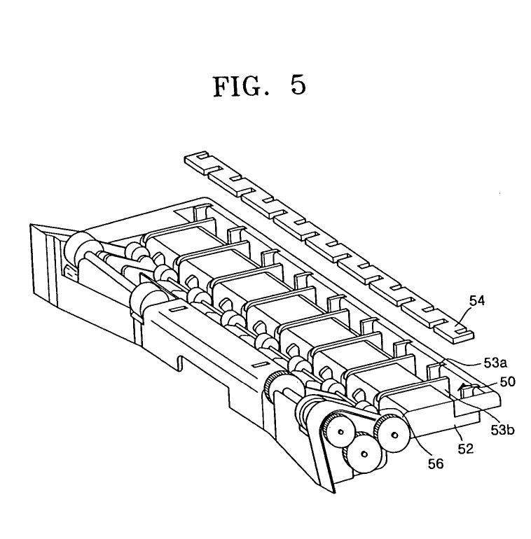

FIG. 5 is a perspective view of the printers according to the embodiments of FIGS. 4A and 4B. Referring to FIG. 5, the ink collector 50 includes a single space portion extending in the scan direction. The first support beam 53a, extending in the paper feed direction, and the second support beam 53b, extending in the opposite direction, are interlaced with each other and serve as support beams, which segment the space portion of the ink collector 50 without partitioning the space. The first support beam 53a extends from the platen 52 at the feeding side, and the second support beam 53b extends from the platen 52 at the discharge side. Reference numeral 56 denotes a discharge roller. As stated supra, reference numeral 54 denotes a felt, which absorbs ink drops in the ink collector 50.

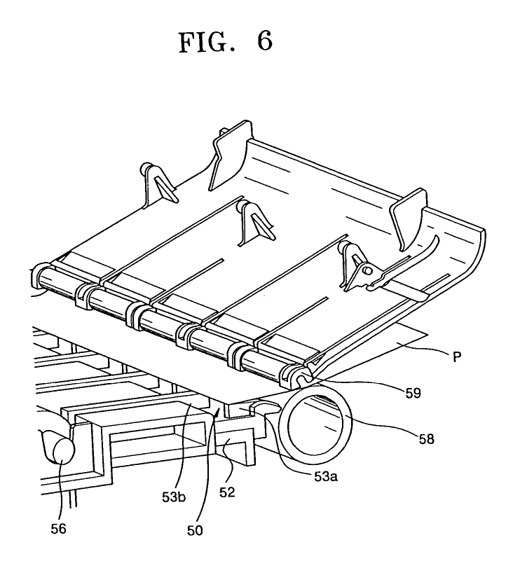

FIG. 6 is a diagram showing a state in which the paper P is fed by the feed roller 58 and the pinch roller 59 and enters above the ink collector 50. The paper P is transported by the feed roller 58 and lands on the first support beam 53a, and then front edge printing starts when ink is ejected by a nozzle unit (not shown). A shingling mode providing front edge printing is implemented in a printer shown in FIG. 4 by applying data, which is generated by masking data corresponding to the positions of support beams, such as the first and second support beams 53a and 53b, to the ink head 51. Such a shingling mode providing front edge printing or rear edge printing can vary with the structure of the support beams of a printer.

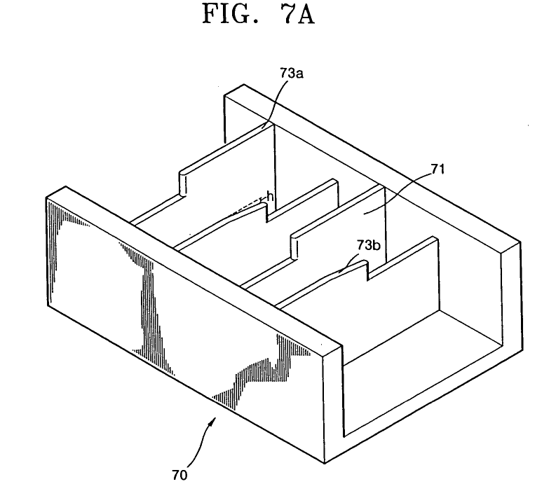

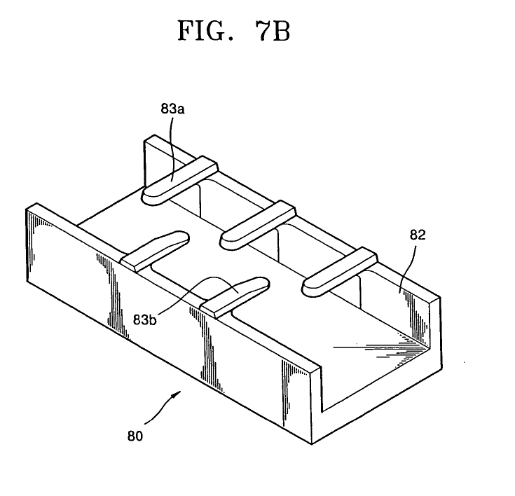

FIGS. 7A and 7B are perspective views of first and second modified examples, respectively, of the ink collector of the printers according to the embodiments of FIGS. 4A and 4B.

Referring to FIG. 7A, an ink collector 70 in the first modified example includes a plurality of space portions separated by a plurality of barriers 71. First and second support beams 73a and 73b alternately extend from the barriers 71 toward an ink head to the same height. The first and second support beams 73a and 73b are integrally formed with the barriers 71 as parts of the barriers 71. The first support beam 73a extends from a paper feed side in a paper feed direction while the second support beam 73b extends from a paper discharge side in an opposite direction to the paper feed direction. The end portions of the first and second support beams 73a and 73b are arranged alternately or to face each other so that a paper jam can be prevented. An ink absorbing member, such as a felt, can be further provided within the ink collector 70 in order to more efficiently collect ink. In particular, the second support beam 73b extending from the paper discharge side can be formed to have a round end or a gradual slanting inclination in the paper feed direction, as shown in FIG. 7A, in order to prevent a paper jam. In FIG. 7A, a reference character “h” denotes a difference between the full height of the second support beam 73a and the height thereof at the end of the slanting edge.

Referring to FIG. 7B, in the second modified example, an ink collector 80 includes a plurality of first and second support beams 83a and 83b, respectively, such that a space in the ink collector 80 continues without being blocked. The first support beams 83a extend from the ink collector 80 at the paper feed side in the paper feed direction while the second support beams 83b extend from the ink collector 80 at the paper discharge side in an opposite direction to the paper feed direction. The ink collector 80 also includes a wall 82 having a predetermined height to define the space of the ink collector 80. The first and second support beams 83a and 83b, respectively, may be arranged at the top of the wall 82 such that their end portions face each other or alternate with each other. In FIG. 7B, the first support beams 83a, serving as support beams at the paper feed side, alternate with the second support beams 83b, serving as support beams at the paper discharge side. Here, the second support beams 83b are formed to have a round end or a gradual slant so that a paper jam can be prevented.

In order to perform printing from a front edge to a rear edge without leaving a margin, the present invention provides a shingling algorithm providing edge printing along with the above-described printer.

In a conventional shingling method or an interlaced printing method, consecutive printing swatches are made to overlap with each other so that a high-resolution image can be printed. However, in a shingling method providing edge printing according to the present invention, a printing position in a scan direction is divided.

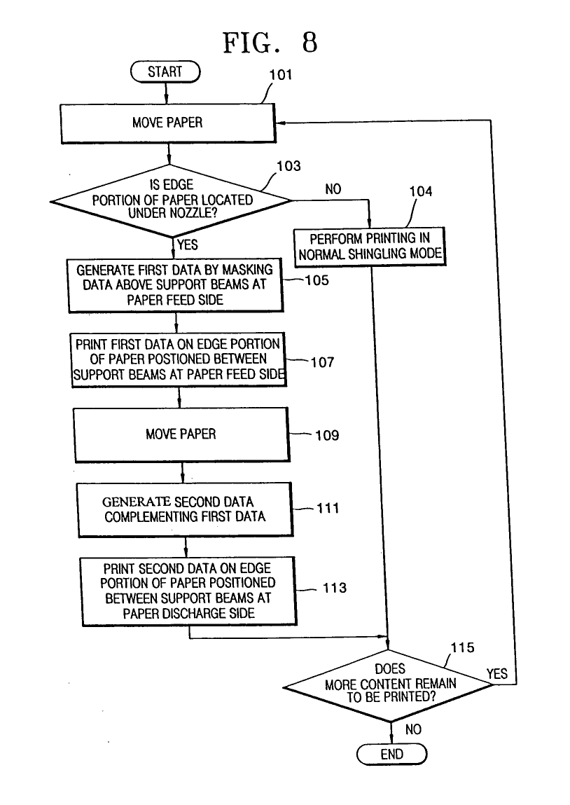

FIG. 8 is a flowchart of a shingling algorithm according to another embodiment of the present invention. Paper is moved in a paper feed direction by rotating a paper feed motor in operation 101. If it is determined that a front or rear edge portion of the paper is located under a nozzle unit in operation 103, first data is generated by masking data corresponding to the positions of the first support beams 53a at a paper feed side in operation 105. However, if it is determined that the front or rear edge portion of the paper is not located under the nozzle unit, printing is performed in a normal shingling mode in operation 104. After completing the printing in the normal shingling mode, if it is determined that more content remains to be printed in operation 115, the shingling algorithm goes to operation 101.

Whether the front or rear edge portion of the paper is located under the nozzle unit can be determined using a sensor. When the front or rear edge portion of the paper is located under the nozzle unit, as shown in FIG. 4A, the front or rear edge portion of the paper lands on the support beams at the paper feed side. The first data is applied to the nozzle unit and thus printed on the front or rear edge portion of the paper, which is positioned between the support beams, in operation 107. Next, the paper is moved in operation 109. It is possible that the paper feed motor is rotated to move the paper by ½ of the entire width of the nozzle unit at one time. In other words, one half of the nozzle unit scans the support beams at the paper feed side, and the other half scans supports beams at a paper discharge side.

If the paper is moved and lands on the second support beams 53b at the paper discharge side, as shown in FIG. 4B, second data complementing the first data is generated in operation 111. The second data is applied to the nozzle unit and thus printed on the front or rear edge portion of the paper between the support beams at the paper discharge side in operation 113. Since the first data has a complementary relationship with the second data, when both first and second data are printed, edge printing is completed. Next, it is determined whether more content remains to be printed in operation 115. If it is determined that more content remains to be printed, the shingling algorithm goes to operation 101. However, if it is determined that no more content remains to be printed, the shingling algorithm ends.

A shingling method providing edge printing according to the present invention can accomplish the high resolution of an image by performing shingling in the paper feed direction, like the conventional shingling method, along with shingling in the scan direction.

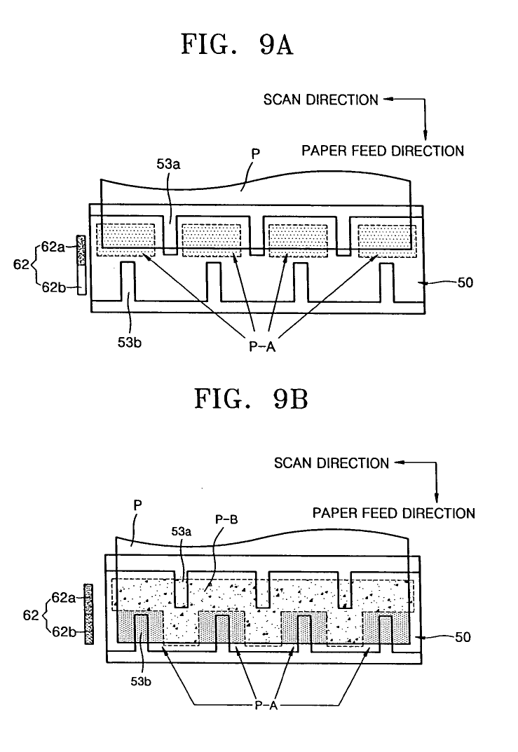

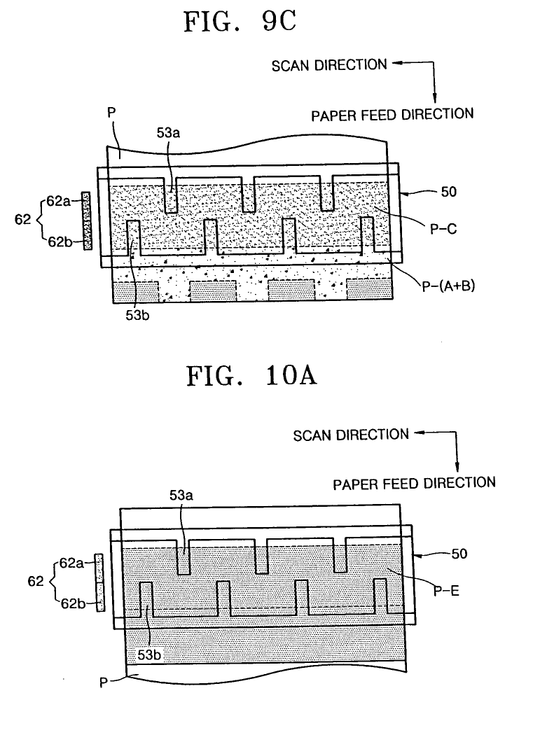

FIGS. 9A through 9C are diagrams showing the stages in a shingling method providing front edge printing according to the embodiment of FIG. 8.

Referring to FIG. 9A, when a front portion of a paper P is moved and located on first support beams 53a at a paper feed side and under the nozzle unit 62, a first section 62a of the nozzle unit 62 ejects ink so that printing is performed on the front edge portion of the paper P, which is positioned between the first support beams 53a. Here, in order to prevent the first support beams 53a from being contaminated, among data to be printed on the front edge portion of the paper P, part of the data, which corresponds to the positions of the first support beams 53a, is masked, thereby generating first data. Accordingly, in a first stage in the shingling method providing front edge printing, data is printed only on a part of the paper P, which is positioned between the first support beams 53a. A reference character P-A denotes a printing area, in which the first data has been printed after completion of the first stage.

Referring to FIG. 9B, after the first stage for the front edge printing is completed, as shown in FIG. 9A, in a second state a paper feed motor is rotated by half of the width of the nozzle unit 62 so that the paper P is moved under a second section 62b of the nozzle unit 62. When the front edge portion of the paper P lands on second support beams 53b at a paper discharge side, second data complementing the first data is generated and printed in a printing area P-B. When the first support beams 53a are interlaced with the second support beams 53b and when the second data is generated and printed, the data corresponding to the position of the second support beam 53b is masked, and thus printing is not performed on the portion of the paper P which is positioned on the second support beams 53b. Here, the second data is applied to the second section 62b of the nozzle unit 62, and data is applied to the first section 62a of the nozzle unit 62 such that printing is performed on the paper P in normal shingling mode. When the second stage is completed, the front edge printing is completed.

The first and second data are in a complementary relationship and are printed at complementary positions in the scan direction in shingling mode for front edge printing, according to this embodiment of the present invention.

The shingling method providing front edge printing according to this embodiment can be applied to any structure, in which support beams are formed as shown in FIGS. 4A through 7B, or in which support beams at a paper feed side alternate with support beams at a paper discharge side so as to effectively support the paper P and an ink collector is formed to collect ink through spaces between the support beams.

FIG. 9C shows a third stage, in which printing is performed in the normal shingling mode, after the shingling method providing front edge printing is completed in the first and second stages and then the paper P is moved. The first and second sections 62a and 62b of the nozzle unit 62 eject ink in the normal shingling mode so that printing for a medium portion of the paper P is performed. A reference character P-(A+B) denotes a printing area in which front edge printing has been completed through the first and second stages. A reference character P-C denotes a printing area in which printing for the medium portion of the paper P has been performed in the normal shingling mode in the third stage.

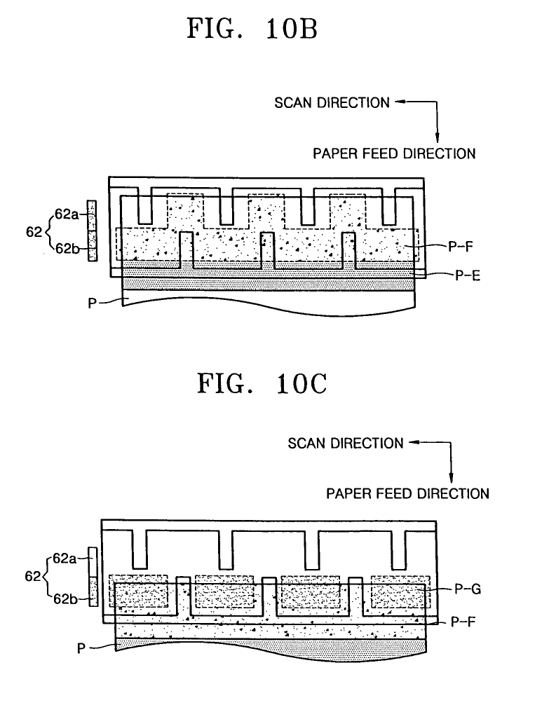

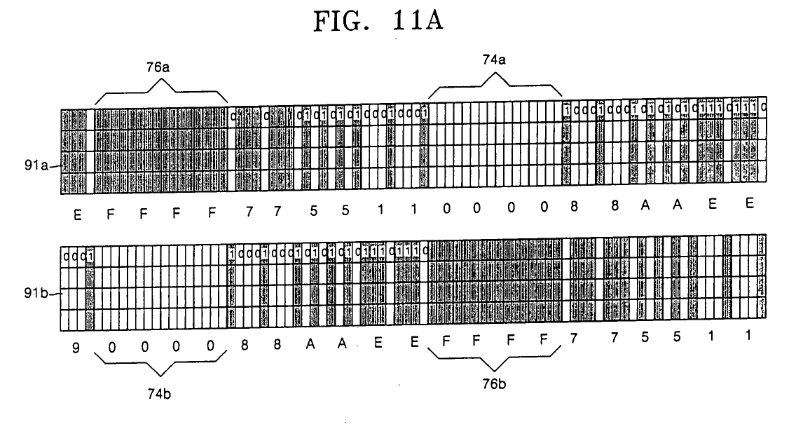

FIGS. 10A through 10C are diagrams showing the stages in a shingling method providing rear edge printing according to another embodiment of the present invention.

As shown in FIG. 10A, printing is performed in the normal shingling mode by ejecting ink using the first and second sections 62a and 62b of the nozzle unit 62. Thereafter, as shown in FIG. 10B, when a rear edge of the paper P is moved under the nozzle unit 62, printing is performed on the paper P except for a part of the paper P positioned on the first support beams 53a. For this operation, first data, which is generated by masking data corresponding to the positions of the first support beams 53a among data to be printed on the rear end portion of the paper P, is applied to the first section 62a of the nozzle unit 62. A reference character P-E denotes a printing area in which printing has been performed in the normal shingling mode. A reference character P-F denotes a printing area in which a first stage of the shingling method for rear edge printing, according to this embodiment of the present invention, has been performed.

After completing the first stage, the paper P is moved by half of the width of the nozzle unit 62. Next, as shown in FIG. 10C, second data complementing the first data is applied to the second section 62b of the nozzle unit 62, and thus printed on the rear edge portion of the paper P positioned on the second support beams 53b at the paper discharge side in a second stage. A printing area P-G in the second stage is positioned between the second support beams in a complementary relationship with the printing area P-F in the first stage.

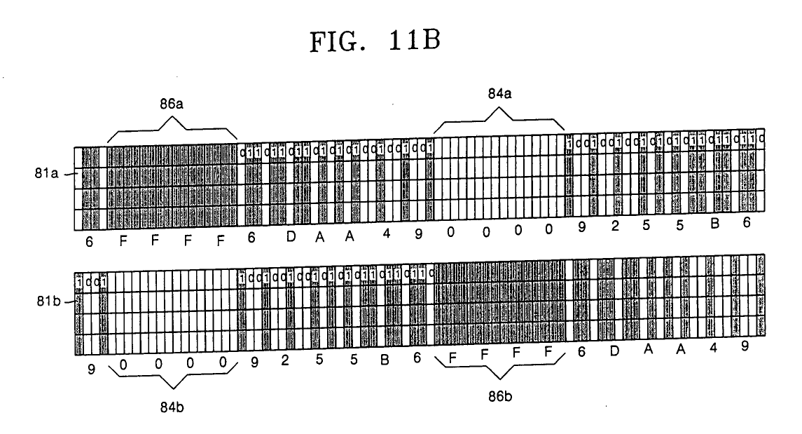

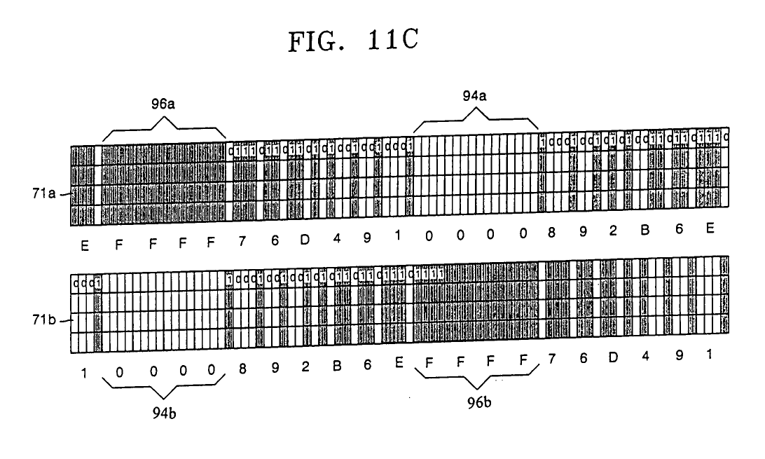

FIGS. 11A through 11C are diagrams showing examples of masks used in a shingling method providing edge printing according to embodiments of the the present invention. Each of the example masks is represented using a hexadecimal number system.

When edge printing without a margin is performed, a borderline may appear between the printing areas P-A and P-B in FIG. 9B and between the printing areas P-F and P-G in FIG. 10C, thereby degrading picture quality. In other words, when a shingling method providing edge printing is performed, printing in the printing areas P-A and P-B or P-F and P-G is not simultaneously performed, and thus ink ejected on the paper P is dried at different times. As a result, a borderline appears between these printing areas. In order to overcome this problem, the present invention provides a mask, which filters image data for edge printing.

Masks are paired, and the masks in a pair are in a complementary relationship. Accordingly, a complete image can be formed only after both masks of a mask pair are processed. During edge printing, one mask of the mask pair is repeatedly used for one raster in a scan direction, and the other of the mask pair is repeatedly used for the other raster in the scan direction, so that a complete image is formed. In each mask, a 100% printing column 1 to print image data in the scan direction of a nozzle unit and a 0% printing column 0 to not print image data at all are periodically repeated. Data corresponding to the positions of support beams is filtered by continuously repeating the 0% printing columns 0 so that the support beams are prevented from being contaminated.

Referring to FIG. 11A, when a support beam at a paper feed side is located in a 0% printing area 74a of a first mask 91a, in which the 0% printing columns 0 are continuously repeated, a support beam at a paper discharge side is located in a 0% printing area 74b of a second mask 91b. A number of consecutive 0% printing columns 0, which are alternately distributed with the 100% printing columns 1, gradually change in inverse proportion to the number of consecutive 100% printing columns 1 from the borders of each of the 0% printing areas 74a and 74b at both sides thereof so that degradation of a picture quality can be prevented at both sides the 0% printing areas 74a and 74b. The 0% printing columns 0 and the 100% printing columns 1 are distributed in the same manner as described above from the borders of each of 100% printing areas 76a and 76b at both sides thereof so that degradation of the picture quality can be prevented.

In FIG. 11B, a first mask 81a and a second mask 81b have complementary data arrays, respectively, in a hexadecimal number system. A number of consecutive 0% printing columns 0, which are alternately distributed with the 100% printing columns 1, gradually change in inverse proportion to the number of consecutive 100% printing columns 1, between 100% printing areas 86a and 86b and 0% printing areas 84a and 84b, respectively, so that degradation of the picture quality can be prevented.

Like the first and second masks 91a, 81a, 91b, and 81b shown in FIGS. 11A and 11B, first and second masks 71a and 71b shown in FIG. 11C have complementary data arrays, respectively, in a hexadecimal number system. A number of consecutive 0% printing columns 0, which are alternately distributed with the 100% printing columns 1, gradually change in inverse proportion to the number of consecutive 100% printing columns 1, between 100% printing areas 96a and 96b and 0% printing areas 94a and 94b, respectively, so that degradation of the picture quality can be prevented.

As described above, the present invention uses masks, as shown in FIG. 11A, 11B, or 11C, in order to remove a borderline between a printing area in which printing is performed on paper except for a part corresponding to support beams, and a printing area in which printing is performed on the part of the paper corresponding to the support beams. Consequently, degradation of picture quality can be prevented.

In a printer according to an embodiment of the present invention, an ink collector has a structure suitable to shingling providing edge printing. In particular, support beams extending from one side of an ink collector in a paper feed direction are interlaced with support beams extending from the other side thereof in an opposite direction to the paper feed direction, so that a shingling algorithm providing edge printing can be variously applied without contaminating the support beams and the front and rear edge portions of paper can be effectively supported. In a printer according to the present invention, various modifications can be made to support beams.

The present invention provides a shingling method providing edge printing so that printing can be performed on the front and rear edge portions of paper without leaving a margin and without contaminating support beams. The present invention also uses filtering masks to gradually print data in an area between support beams so that degradation of picture quality can be prevented.

As described above, in a printer providing edge printing according to the embodiments of the present invention, support beams of an ink collector are alternately arranged with each other, thereby effectively supporting the front and rear edge portion of paper and efficiently collecting ink digressing from the paper.

In a shingling method providing edge printing according to the present invention, printing can be performed on the front and rear edge portions of paper at a high resolution without leaving a margin and without contaminating support beams.

While this invention has been particularly shown and described with reference to the embodiments thereof, the embodiments should be considered in a descriptive sense only and not for purposes of limitation. Although a few embodiments of the present invention have been shown and described, it will be appreciated by those skilled in the art that changes may be made in these embodiments without departing from the principles and spirit of the invention, the scope of which is defined in the appended claims and their equivalents. For example, the shape of an ink collector or the positions of support beams can be changed by those skilled in the art without departing from the spirit of the invention. Therefore, the scope of the invention is defined not by the detailed description of the invention but by the appended claims.

What is claimed is:

1. A printer comprising:
an ink head comprising a nozzle unit to eject ink drops in a shingling mode providing edge printing;
an ink collector positioned under paper to correspond to the nozzle unit and collect ink digressing from the paper; and
a plurality of support beams extending at an upper portion of the ink collector in a paper feed direction and in an opposite direction to the paper feed direction and alternately arranged with each other in a scan direction.

2. The printer of claim 1, wherein the support beams comprise:
a first support beam extending from a paper feed side of the ink collector in the paper feed direction; and
a second support beam extending from a paper discharge side of the ink collector in the opposite direction to the paper feed direction.

3. The printer of claim 2, wherein the first and second support beams extend to have the same length to support the paper.

4. The printer of claim 3, wherein an end point of the first support beam and an end point of the second support beam face each other in the scan direction.

5. The printer of claim 3, wherein the end portion of the first support beam extends in the paper feed direction to interlace with that of the second support beam.

6. The printer of claim 4, wherein one first and second support beams have the same height in a direction toward the ink head, the direction perpendicular to the paper feed direction and the scan direction.

7. The printer of claim 5, wherein the first and second support beams have the same height in a direction toward the ink head, the direction perpendicular to the paper feed direction and the scan direction.

8. The printer of claim 7, wherein the support beam extends from a barrier, which partitions the ink collector.

9. The printer of claim 7, wherein the support beam is a rib segmenting a space of the ink collector without partitioning it.

10. The printer of claim 2, wherein the second support beam has a round end portion.

11. The printer of claim 2, wherein the second support beam has a slant end portion inclining in the paper feed direction.

12. A shingling method to provide edge printing, comprising:
feeding paper such that an edge portion of the paper is located under a nozzle unit of an ink head and printing first data on the edge portion of the paper positioned between support beams supporting the paper, the first data being generated by masking data corresponding to positions of the support beams; and
moving the paper in a paper feed direction by a predetermined width and printing second data on the edge portion of the paper positioned between support beams.

13. The shingling method of claim 12, wherein the first data and the second data are in a complementary relationship.

14. The shingling method of claim 12, wherein in the paper feeding operation, masking is performed using a first mask in which a number of consecutive 0% printing columns, which are alternately distributed with a number of 100% printing columns, gradually changes in inverse proportion to the number of consecutive 100% printing columns in a scan direction perpendicular to the paper feed direction.

15. The shingling method of claim 14, wherein in the paper moving operation, the second data is generated by performing masking using a second mask, which is in a complementary relationship with the first mask.

16. The shingling method of claim 12, wherein in the paper feeding operation, the support beams extend from a paper feed side in the paper feed direction.

17. The shingling method of claim 16, wherein in the paper moving operation, the support beams extend from a paper discharge side in an opposite direction to the paper feed direction and interlace with the support beams extending from the paper feed side.

18. The shingling method of claim 16, wherein the support beams are part of an ink collector collecting ink digressing from the paper.

19. The shingling method of claim 17, wherein the support beams are part of an ink collector collecting ink digressing from the paper.

20. The shingling method of claim 12, wherein in the paper feeding operation, the paper is fed by ½ of a width of the nozzle unit in the paper feed direction.

21. The shingling method of claim 20, wherein in the paper moving operation, the paper is fed by ½ of the width of the nozzle unit in the paper feed direction.

22. The shingling method of claim 12, wherein in the paper moving operation, the second data is applied to a nozzle section positioned above the edge portion of the paper, and the other nozzle section operates in a shingling mode providing normal printing.

23. The shingling method of claim 12, further comprising moving the paper in the paper feed direction after completing front edge printing in the paper moving operation and performing printing in a normal shingling mode.

24. The shingling method of claim 12, further comprising performing printing in a normal shingling mode before the paper feeding operation, wherein printing is performed in a shingling mode providing rear edge printing in the paper feeding operation.

25. A printer comprising:
an ink head ejecting ink drops at an edge of a printing medium;
an ink collector positioned under the printing medium to collect excess ink from the printing medium;
a plurality of first support beams extending at an upper portion of the ink collector in a printing medium feed direction to support the printing medium at a printing medium feed side of the ink collector; and
a plurality of second support beams extending at an upper portion of the ink collector in an opposite direction to the printing medium feed direction and alternately arranged with the plurality of first support beams to support the printing medium at a printing medium discharge side of the ink collector.

26. The printer of claim 25, wherein the ink head comprises an ink nozzle to eject ink drops on the printing medium when the ink head moves in a scan direction.

27. The printer of calim 26, wherein the ink collector is located under the printing medium and has a width corresponding to the width of the nozzle unit.

28. The printer of calim 26, wherein the ink collector is located under the printing medium and has a width wider than the width of the nozzle unit.

29. The printer of claim 27, wherein the ink collector further comprises:
a floor portion; and
a space portion having an opening above the floor portion to catch ink drops.

30. The printer of claim 29, wherein the space portion comprises a felt to absorb the ink drops caught by the space portion.

31. The printer of claim 25, wherein the ink collector comprises:
a plurality of space portions; and
a plurality of barriers separating the plurality of space portions,
wherein the first and second support beams integrally extend from the barriers alternately with respect to each other.

32. A printer comprising:
an ink head ejecting ink drops at an edge of a printing medium;
an ink collector positioned under the printing medium to collect excess ink from the printing medium;
a plurality of first support beams extending at an upper portion of the ink collector in a printing medium feed direction to support the printing medium at a printing medium feed side of the ink collector; and
a plurality of second support beams extending from an upper portion of the ink collector at a printing medium discharge side of the ink collector and in an opposite direction to the printing medium feed direction, the plurality of second support beams being overlapped by the plurality of first support beams to support the printing medium during feeding thereof between the ink head and the ink collector.

33. A shingling method to provide edge printing, comprising:
feeding a printing medium passed ink nozzles of an ink head;
printing first data on a front edge portion of the printing medium at positions between a set of support beams supporting the printing medium; and
moving the printing medium in a feed direction by a predetermined distance and printing second data on the front edge portion of the printing medium at positions complimentary to the first data such that the complete edge of the printing medium receives printing data.

34. The shingling method of claim 33, wherein in the printing medium feeding operation, the first data is generated by performing masking using a first mask.

35. The shingling method of claim 34, wherein in the printing medium moving operation, the second data is generated by performing masking using a second mask, which is in a complementary relationship with the first mask.

36. The shingling method of claim 35, wherein masking is performed using a first mask in which a number of consecutive 0% printing columns, which are alternately distributed with a number of 100% printing columns, gradually changes in inverse proportion to the number of consecutive 100% printing columns in a scan direction perpendicular to the printing medium feeding direction.

37. The shingling method of claim 33, further comprising:
moving the printing medium in the feeding direction after completing front edge printing and performing normal shingling printing;
printing the first data on a rear edge portion of the printing medium at positions between a set of support beams supporting the printing medium; and
moving the printing medium in a feed direction by a predetermined distance and printing the second data on the rear edge portion of the printing medium at positions complimentary to the first data such that the complete edge of the printing medium receives printing data.

38. The shingling method of claim 37, wherein in the printing medium feeding operation, the first data is generated by performing masking using a first mask and the second data is generated by performing masking using a second mask, which is in a complementary relationship with the first mask.

39. The shingling method of claim 38, wherein masking is performed using a first mask in which a number of consecutive 0% printing columns, which are alternately distributed with a number of 100% printing columns, gradually changes in inverse proportion to the number of consecutive 100% printing columns in a scan direction perpendicular to the printing medium feeding direction.
